(19) United States
(12) Patent Application Publication
(10) Pub. No.: US 2024/0130923 A1
(43) Pub. Date: Apr. 25, 2024

(54) ADAPTIVE SEAT MASSAGE SYSTEM AND METHOD OF CONTROLLING THE SAME

(71) Applicants: Hyundai Motor Company, Seoul (KR); Kia Corporation, Seoul (KR)

(72) Inventors: Ming LI, Yantai (CN); Joo Hwan SON, Anyang-Si (KR); Hai Yan ZHAO, Yantai (CN); Xiang Lai NIAN, Yantai (CN); Junshuai CAO, Yantai (CN); Shinjin KANG, Suwon-Si (KR); Shi Hua WANG, Yantai (CN)

(73) Assignees: Hyundai Motor Company, Seoul (KR); Kia Corporation, Seoul (KR)

(21) Appl. No.: 18/079,645

(22) Filed: Dec. 12, 2022

(30) Foreign Application Priority Data
Oct. 19, 2022 (CN) 202211288094.8

(51) Int. Cl. A61H 7/00; B60N 2/90

(52) U.S. Cl. CPC A61H 7/001; B60N 2/976; A61H 2201/0149; A61H 2201/5002; A61H 2201/5007; A61H 2201/5071; A61H 2203/0431; A61H 2230/625; A61H 2230/805; A61H 2230/855; B60N 2/70

(57) ABSTRACT

An adaptive seat massage system and a method of controlling the same include a massage module providing a massage function in a plurality of regions of a seat; a pressure measurement module detecting pressure applied to the seat by a user in the regions of the seat and transmits pressure measurement signal corresponding to respective regions among the plurality of regions; and a control module determining whether to operate the massage module in at least one region based on the pressure measurement signal received from the pressure measurement module, determining, when the massage module is operated in the at least one region, an operating mode of the massage module in the at least one region based on the pressure measurement signal, and transmitting a control signal corresponding to the determined operating mode to the massage module to control an operation of the massage module in the at least one region.

### CROSS-REFERENCE TO RELATED APPLICATION

The present application claims priority to and the benefit of Chinese Patent Application No. 202211288094.8 filed in the Chinese National Intellectual Property Administration on Oct. 20, 2022, the entire contents of which is incorporated herein for all purposes by this reference.

### BACKGROUND OF THE PRESENT DISCLOSURE

### Field of the Present Disclosure

The present disclosure relates to a field of massage seats for vehicles, and to an adaptive seat massage system configured for adaptively adjusting a massage function of a massage seat according to a user's body type, weight, and sitting posture, and a method of controlling the same.

### Description of Related Art

With the development of vehicle technologies, people's demand for the power, economical efficiency, safety, maneuverability, and ride comfort of vehicles has been increased. Recently, to increase marketability by improving vehicle ride comfort, vehicle manufacturers provide a seat massage function interface through an audio video navigation telematics (AVNT) system in vehicles so that users may turn on or off a massage function of a massage seat.

Currently, vehicle manufacturers set one or more fixed massage modes for mass-produced vehicle massage seats. When a massage switch is turned on, the massage seat massages the user according to a fixed program or mode. However, different users have different body types, weights, and sitting postures, and even the same user may take different sitting postures whenever he or she sits. Therefore, when a user is massaged in a fixed program or mode, the massage intensity and the massage effect that the user may feel may be very different, and thus user's needs for ride comfort cannot be satisfied. In addition, in a massage seat using a fixed program or mode, all the massage heads are normally operated at the same time, even if the user's body does not touch a portion of the seat, and the massage head in the corresponding region continues to operate, resulting in poor massage efficiency.

Therefore, there is a demand for a technology capable of adaptively adjusting a massage function of a massage seat according to a user's body type, weight, and sitting posture

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an adaptive seat massage system and method of controlling the same including advantages of adaptively adjusting a massage function of a massage seat according to a user's body type, weight, and sitting posture.

Various aspects of the present disclosure are directed to providing an adaptive seat massage system including: a massage module configured to provide a massage function in a plurality of regions of a seat; a pressure measurement module configured to detect pressure applied to the seat by a user in the plurality of regions of the seat and transmit pressure measurement signal corresponding to respective regions among the plurality of regions; and a control module electrically connected to the massage module and the pressure measurement module and configured to determine whether to operate the massage module in at least one region among the plurality of regions, based on the pressure measurement signal received from the pressure measurement module, determine, when the massage module is operated in the at least one region, an operating mode of the massage module in the at least one region based on the pressure measurement signal, and transmit a control signal corresponding to the determined operating mode to the massage module to control an operation of the massage module in the at least one region.

The control module may include a processing unit configured to, when the pressure measurement signal is received from the pressure measurement module, process the received pressure measurement signal to obtain cell pressure data, determine an effective contact area ratio of each region among the plurality of regions based on the cell pressure data, and compare the determined effective contact area ratio of each region with a predetermined massage operation threshold value to determine whether to operate the massage module in the at least one region.

The processing unit may be further configured to, when it is determined by the processing unit to operate the massage module in the at least one region, determine a seat pressure distribution value of the at least one region based on the cell pressure data and compare the determined seat pressure distribution value of the at least one region with a predetermined pressure distribution threshold value to determine the operating mode of the massage module in the at least one region.

The processing unit may be further configured to divide each of the regions into m×n cells, obtain m×n cell pressure data based on the pressure measurement signal of each region, compare the m×n cell pressure data with a predetermined reference pressure, count cells having the cell pressure data equal to or greater than the reference pressure to obtain a count value, divide the count value by a product of m and n to determine an effective contact area ratio of each of the regions, and determine to operate the massage module in a corresponding region when the determined effective contact area ratio of any one of the plurality of regions is equal to or greater than the massage operation threshold value, wherein each of m and n is a positive integer, respectively.

The processing unit may be further configured to, when the massage module is operated in any one of the regions, determine an average value and a variance value for the cell pressure data of the cells having the cell pressure data equal to or greater than the reference pressure in the corresponding region, and divide the determined variance value by a value obtained by multiplying a square of the average value by 4 to determine the seat pressure distribution value of the corresponding region.

The pressure distribution threshold value may include a first pressure distribution threshold value and a second pressure distribution threshold value, and the processing unit may be further configured to determine the operating mode of the massage module in the corresponding region to be a first operating mode when the processing unit concludes that the seat pressure distribution value of any one of the determined regions is smaller than the first pressure distribution threshold value, determine the operating mode of the massage module in the corresponding region to be a second operating mode when the processing unit concludes that the seat pressure distribution value of any one of the determined regions is equal to or greater than the first pressure distribution threshold value and smaller than the second pressure distribution threshold value, and determine the operating mode of the massage module in the corresponding region to be a third operating mode when the processing unit concludes that the seat pressure distribution value of any one of the determined regions is greater than the second pressure distribution threshold value.

A massage intensity of the third operating mode may be higher than a massage intensity of the second operating mode and a massage frequency of the third operating mode may be greater than a massage frequency of the second operating mode, and the massage intensity of the second operating mode may be higher than a massage intensity of the first operating mode and the massage frequency of the second operating mode may be greater than a massage frequency of the first operating mode.

The processing unit may be further configured to determine not to operate the massage module in the corresponding region, when the determined effective contact area ratio of any one of the determined regions is smaller than the massage operation threshold value.

The control module may further include: a storage unit configured to pre-store the reference pressure, the massage operation threshold value, and the pressure distribution threshold value; and a communication unit configured to communicate with the massage module and the pressure measurement module.

The massage module may include a plurality of massage heads, the plurality of massage heads may be arranged in the plurality of regions of the seat, the pressure measurement module may include a plurality of pressure sensor arrays, and the plurality of pressure sensor arrays may be respectively arranged in corresponding regions of the plurality of regions of the seat.

Various aspects of the present disclosure are directed to providing a method of controlling an adaptive seat massage system including: detecting, by a pressure measurement module, pressure applied to a plurality of regions of a seat by a user and transmitting pressure measurement signal corresponding to respective regions among the plurality of regions; and determining, by a control module electrically connected to the pressure measurement module, whether to operate a massage module electrically connected to the control module, in at least one region among the plurality of regions, based on the pressure measurement signal received from the pressure measurement module, determining, when the massage module is operated in the at least one region, an operating mode of the massage module in the at least one region based on the pressure measurement signal, and transmitting a control signal corresponding to the determined operating mode to the massage module to control an operation of the massage module in the at least one region.

The determining whether to operate the massage module in the at least one region by the control module may include processing, when the pressure measurement signal is received from the pressure measurement module, the received pressure measurement signal to obtain cell pressure data, determining an effective contact area ratio of each region among the plurality of regions based on the cell pressure data, and comparing the determined effective contact area ratio of each region with a predetermined massage operation threshold value to determine whether to operate the massage module in the at least one region.

The determining the operating mode of the massage module in the at least one region by the control module may include additionally determining, by the control module, a seat pressure distribution value of the at least one region based on the cell pressure data when it is determined by the control module to operate the massage module in the at least one region, and comparing the determined seat pressure distribution value of the at least one region with a predetermined pressure distribution threshold value to determine the operating mode of the massage module in the at least one region.

The determining whether to operate the massage module in the at least one region by the control module may further include dividing, by the control module, each of the regions into m×n cells, obtaining m×n cell pressure data based on the pressure measurement signal of each region, comparing the m×n cell pressure data with a predetermined reference pressure, counting cells having the cell pressure data equal to or greater than the reference pressure to obtain a count value, dividing the count value by a product of m and n to determine an effective contact area ratio of each of the regions, and determining to operate the massage module in a corresponding region when the determined effective contact area ratio of any one of the plurality of regions is equal to or greater than the massage operation threshold value, wherein each of m and n is a positive integer, respectively.

The determining the operating mode of the massage module in the at least one region by the control module may further include determining, by the control module, an average value and a variance value for the cell pressure data of the cells having the cell pressure data equal to or greater than the reference pressure in the corresponding region when the massage module is operated in any one of the regions, and dividing the determined variance value by a value obtained by multiplying a square of the average value by 4 to determine the seat pressure distribution value of the corresponding region.

The pressure distribution threshold value may include a first pressure distribution threshold value and a second pressure distribution threshold value, and the determining the operating mode of the massage module in the at least one region by the control module may further include: determining the operating mode of the massage module in the corresponding region to be a first operating mode when the control module concludes that the seat pressure distribution value of any one of the determined regions is smaller than the first pressure distribution threshold value, determining the operating mode of the massage module in the corresponding region to be a second operating mode when the control module concludes that the seat pressure distribution value of any one of the determined regions is equal to or greater than the first pressure distribution threshold value and smaller than the second pressure distribution threshold value, and determining the operating mode of the massage module in the corresponding region to be a third operating mode when the control module concludes that the seat pressure distribution value of any one of the determined regions is greater than the second pressure distribution threshold value.

A massage intensity of the third operating mode may be higher than a massage intensity of the second operating mode and a massage frequency of the third operating mode may be greater than a massage frequency of the second operating mode, and the massage intensity of the second operating mode may be higher than a massage intensity of the first operating mode and the massage frequency of the second operating mode may be greater than a massage frequency of the first operating mode.

When the determined effective contact area ratio of any one of the plurality of regions is smaller than the massage operation threshold value, the control module may determine not to operate the massage module in the corresponding region.

The advantages of the present disclosure are as follows:

The pressure applied by the user's body to different regions of the seat is separately measured by use of a plurality of pressure measurement units respectively disposed in different regions of the seat and massage heads of the massage module of the seat are dividedly operated by regions and a massage intensity/frequency is controlled dividedly by regions according to different pressures applied to different regions, so that the massage function of the massage seat may be adaptively adjusted according to the user's body type, weight, and sitting posture.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows a schematic diagram of an adaptive seat massage system according to various exemplary embodiments of the present disclosure.

FIG. 2 is a block diagram showing a configuration of an adaptive seat massage system according to various exemplary embodiments of the present disclosure.

FIG. 3 shows a schematic diagram illustrating that a plurality of regions of a seat includes a plurality of cells according to various exemplary embodiments of the present disclosure.

FIG. 4 is a flowchart illustrating a process of a method of controlling an adaptive seat massage system according to various exemplary embodiments of the present disclosure.

FIG. 5 is a flowchart illustrating a process of determining an effective contact area ratio (EAR) in the method of controlling an adaptive seat massage system according to various exemplary embodiments of the present disclosure shown in FIG. 4.

FIG. 6 is a flowchart illustrating a process of determining the seat pressure distribution (SPD) value in the method of controlling an adaptive seat massage system according to various exemplary embodiments of the present disclosure shown in FIG. 4.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments will be described below with reference to the accompanying drawings. While the present disclosure is described in conjunction with exemplary embodiments of the present disclosure, it is to be understood that the present specification is not intended to limit the present disclosure to the exemplary embodiments of the present disclosure. Furthermore, the present disclosure may include not only exemplary embodiments of the present disclosure, but also various alternative, modified, equivalent, and other implementations within the spirit and scope defined by the appended claims.

It should be understood that when one component is referred to as being “connected” to another component, it may be directly or indirectly connected to another component, and the indirect connection includes “connection” through a wireless communication network.

When the term “including” is used in an exemplary embodiment of the present disclosure, it means that the feature, number, step, operation, element and/or assembly is present, but does not exclude the presence or addition of one or more other features, values, steps, operations, elements, assemblies, and/or combinations thereof.

In the present specification, each element may be described using terms such as “first” and “second”, but it will be understood that these elements are not limited by these terms.

Hereinafter, the operating principle and implementation method of the present disclosure will be described in detail with reference to the accompanying drawings.

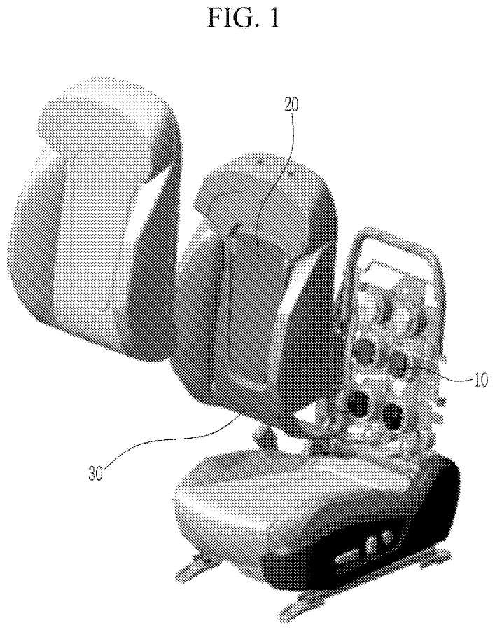

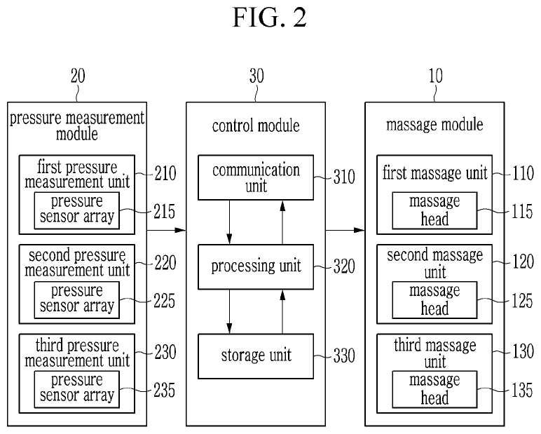

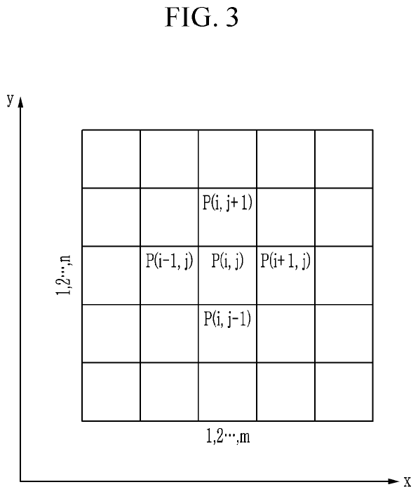

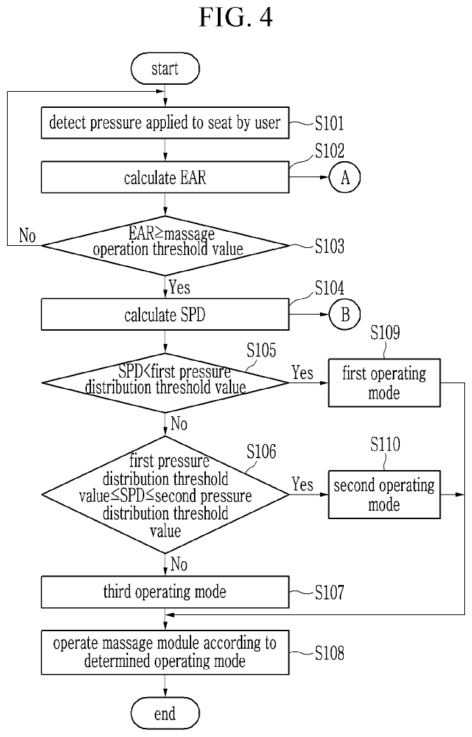

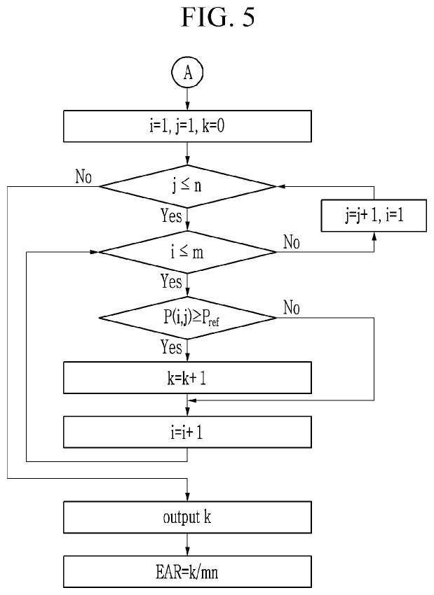

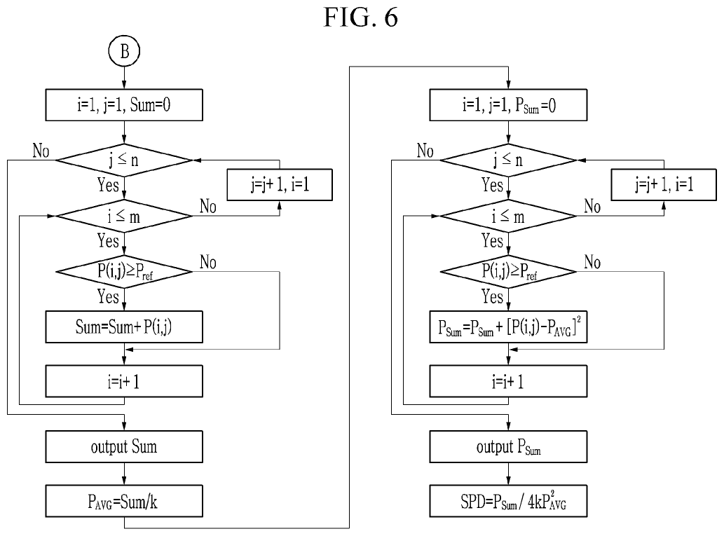

FIG. 1 shows a schematic diagram of an adaptive seat massage system according to various exemplary embodiments of the present disclosure, FIG. 2 is a block diagram showing a configuration of an adaptive seat massage system according to various exemplary embodiments of the present disclosure, FIG. 3 shows a schematic diagram illustrating that a plurality of regions of a seat includes a plurality of cells according to various exemplary embodiments of the present disclosure, FIG. 4 is a flowchart illustrating a process of a method of controlling an adaptive seat massage system according to various exemplary embodiments of the present disclosure, FIG. 5 is a flowchart illustrating a process of determining an effective contact area ratio (EAR) in the method of controlling an adaptive seat massage system according to various exemplary embodiments of the present disclosure shown in FIG. 4, and FIG. 6 is a flowchart illustrating a process of determining the seat pressure distribution (SPD) value in the method of controlling an adaptive seat massage system according to various exemplary embodiments of the present disclosure shown in FIG. 4.

As shown in FIG. 1 and FIG. 2, an adaptive seat massage system according to various exemplary embodiments of the present disclosure includes a massage module 10, a pressure measurement module 20, and a control module 30. The massage module 10 is configured to provide a massage function in a plurality of regions of the seat when a user operates the seat massage function. The pressure measurement module 20 is configured to detect a pressure applied by the user to a seat in the plurality of regions of the seat and transmit a pressure measurement signal corresponding to each region among the plurality of regions, respectively. The control module 30 is configured to determine whether to operate the massage module 10 in at least one region based on the pressure measurement signal received from the pressure measurement module 20, determine, when the massage module 10 is operated in the at least one region, an operating mode of the massage module 10 in the at least one region based on the pressure measurement signal, and transmit a control signal corresponding to the determined operating mode to the massage module to control an operation of the massage module 10 in the at least one region.

In various exemplary embodiments of the present disclosure, the massage module 10 is mounted on a frame of the seat, the massage module 10 is covered with a foam pad, the pressure measurement module 20 is disposed in the foam pad, and the pressure measurement module 20 is covered with a seat skin. Furthermore, the pressure measurement module 20 includes a plurality of pressure sensor arrays 215, 225 and 235, and the plurality of pressure sensor arrays 215, 225 and 235 are respectively arranged in corresponding regions among the plurality of regions of the seat. Therefore, compared to the related art, the pressure measurement module 20 according to various exemplary embodiments of the present disclosure has higher pressure measurement sensitivity and accuracy.

In various exemplary embodiments of the present disclosure, the seat may include the plurality of regions. For example, a seatback may include three regions based on a seatback reference point (point H). Based on the point H, a seatback region from the point H to a point H+150 mm may be defined as a first region, a seatback region from the point H+150 mm to a point H+260 mm may be defined as a second region, and a seatback region from the point H+260 mm to a point H+390 mm may be defined as a third region. The first region corresponds to a waist region, the second region corresponds to a back region, and the third region corresponds to a shoulder region. Although only one example is shown here, any suitable method for dividing regions may be applied to the present disclosure.

Correspondingly, the massage module 10 according to various exemplary embodiments of the present disclosure includes three massage units, that is, a first massage unit 110, a second massage unit 120, and a third massage unit 130. The first massage unit 110 is disposed in the first region to provide a massage function in the first region, the second massage unit 120 is disposed in the second region to provide a massage function in the second region, and the third massage unit 130 is disposed in the third region to provide a massage function in the third region. The first massage unit 110, the second massage unit 120, and the third massage unit 130 each include a plurality of massage heads 115, 125 and 135.

Correspondingly, the pressure measurement module 20 according to various exemplary embodiments of the present disclosure includes three pressure measurement units, that is, a first pressure measurement unit 210, a second pressure measurement unit 220, and a third pressure measurement unit 230. The first pressure measurement unit 210 is disposed in the first region, measures a pressure applied by the user's body to the seatback in the first region, and provides a pressure measurement signal of the first region; the second pressure measurement unit 220 is disposed in the second region, measures a pressure applied by the user's body to the seatback in the second region, and provides a pressure measurement signal of the second region; and the third pressure measurement unit 230 is disposed in the third region, measures a pressure applied by the user's body to the seatback in the third region, and provides a pressure measurement signal of the third region. The first pressure measurement unit 210, the second pressure measurement unit 220, and the third pressure measurement unit 230 each include a pressure sensor array 215, 225 and 235.

The control module 30 according to various exemplary embodiments of the present disclosure may be integrally formed with an electronic control unit (ECU) of a vehicle or connected to the electronic control unit of the vehicle through a separate connector to be implemented separately from the electronic control unit of the vehicle. The control module 30 includes a communication unit 310, a processing unit 320 and a storage unit 330. The communication unit 310 may communicate with the massage module 10 and the pressure measurement module 20 to transmit and receive signals. The storage unit 330 may store programs and/or data for operating the massage module 10 and programs and/or data for generating control signals corresponding to different operating modes for the processing unit 320. The processing unit 320 may execute various data processing and data manipulation, and may include a micro control unit (MCU).

The storage unit 330 may be implemented as a non-volatile memory, such as a cache memory, a read only memory (ROM), a programmable ROM (PROM), an erasable programmable ROM (EPROM), an electrically erasable programmable ROM (EEPROM), and a flash memory, a volatile memory, such as a random access memory (RAM), or a storage medium, such as a Hard Disk Drive (HDD) or a CD-ROM, but is not limited thereto.

The communication unit 310 may communicate through a vehicle communication network. For example, the communication unit 310 may perform data communication through an Ethernet communication network, media oriented systems transport (MOST), FlexRay, controller area network (CAN), local interconnect network (LIN), or the like.

When the user operates the massage function of the massage seat through a seat massage function interface of an audio video navigation telematics (AVNT) system, the processing unit 320 receives the pressure measurement signals respectively from the first pressure measurement unit 210, the second pressure measurement unit 220, and the third pressure measurement unit 230 of the measurement module 20 through the communication unit 310. When the pressure measurement signal of the first region is received from the first pressure measurement unit 210, the processing unit 320 processes the received pressure measurement signal of the first region to obtain cell pressure data of the first region, determines an effective contact area ratio (EAR) of the first region based on the cell pressure data, and compares the determined EAR of the first region with a predetermined massage operation threshold value to determine whether to operate the first massage unit 110 located in the first region.

Referring to FIGS. 3 and 5, the processing unit 320 divides the first region into m×n regular cells, and when the pressure measurement signal of the first region is received from the first pressure measurement unit 210, the processing unit 320 obtains m×n cell pressure data P(i, j) (here, 1≤i≤m, 1≤j≤n) based on the pressure measurement signal of the first region. Furthermore, the processing unit 320 compares the m×n cell pressure data P(i, j) with a predetermined reference pressure P_{ref} respectively, counts cells having the cell pressure data P(i, j) equal to or greater than the reference pressure P_{ref} to obtain a count value k, and determines the EAR of the first region using Formula 1 below.

$$EAR = \frac{k}{m n} \qquad [ Formula 1 ]$$

If the EAR of the first region is equal to or greater than the massage operation threshold value, the processing unit 320 determines to operate the first massage unit 110 located in the first region, and if the EAR value of the first region is smaller than the massage operation threshold value, the processing unit 320 determines not to operate the first massage unit 110 located in the first region. Here, each of m and n is positive integers and the k is a count value. The count value k is determined from FIG. 5.

In various exemplary embodiments of the present disclosure, when the user does not contact with the seatback, the pressure measurement module 20 detects the pressure applied by the user to the seatback as zero. The predetermined reference pressure P_{ref} may be set to 3 Newtons (N) per square meter, but is not limited thereto. Furthermore, the massage operation threshold value may be a predetermined value (for example, 30%, but is not limited thereto), and the massage operation threshold value may be variably set by a vehicle manufacturer according to different seat types and vehicle types.

When the user sits on the seat, the user's hand or elbow may touch or press the seatback. In the instant case, a pressure measurement result of the pressure measurement module 20 may partially change, which may interfere with the pressure measurement. In various exemplary embodiments of the present disclosure, by determining whether to operate the massage unit in the corresponding region using the EAR, unnecessary operation of the massage head in the massage module due to the partial pressure change may be prevented, improving the massage efficiency. For example, EAR=100% indicates that the user has completely contacted the corresponding region of the seat, EAR=0% indicates that the user has completely departed from the corresponding region of the seat, and EAR 30% indicates that the contact between the user and the corresponding region of the seat is good so that the massage unit in the corresponding region may be operated.

Additionally, when it is determined to operate the first massage unit 110 located in the first region, the processing unit 320 further determines a seat pressure distribution (SPD) value of the first region based on the m×n cell pressure data P(i, j) of the first region. The processing unit 320 determines an operation mode of the first massage unit 110 located in the first region by comparing the determined SPD value of the first region with a predetermined pressure distribution threshold value.

Referring to FIG. 6, when it is determined to operate the first massage unit 110 located in the first region, the processing unit 320 determines an average value and a variance value for the cell pressure data of the cells where the cell pressure data P(i, j) of the first region is equal to or greater than the reference pressure P_{ref}, and determines the SPD value of the first region using Formula 2 below.

$$SPD = \frac{1}{4 K {P}_{A V G}^{2}} {\sum }_{i = 1}^{m} {{\sum }_{j = 1}^{n} [ P ( i , j ) - {P}_{A V G} ]}^{2} \qquad [ Formula 2 ]$$

Here, P(i, j) is cell pressure data, and P_{AVG} is an average value of the cell pressure data of the cells where the cell pressure data is equal to or greater than the reference pressure.

The SPD value indicates a state where the pressure distribution on a surface of the seat is uniform. In general, as the SPD value decreases, the pressure distribution on the surface of the seat is more uniform and general comfort is better, so that the user feels less fatigue, that is, the user's fatigue is low. Conversely, as the SPD value increases, the pressure distribution on the surface of the seat is uneven, so that the user feels fatigue easily, that is, the user's fatigue is high. In various exemplary embodiments of the present disclosure, the user's fatigue in different regions of the seat is predicted by use of the SPD value, and a massage intensity and frequency desired by the user are determined based on a fatigue level, adaptively adjusting the massage function of the massage seat to meet the user's demand for comport.

The determined SPD value of the first region smaller than a first pressure distribution threshold value (e.g., 4%) indicates that the comfort of the first region is good and the user's fatigue is low. Accordingly, the processing unit 320 determines the operating mode of the first massage unit 110 located in the first region to be a first operating mode. In the first operating mode, the massage intensity is lower than a normal massage intensity, and the massage frequency is less than a normal massage frequency.

The determined SPD value of the first region equal to or greater than a second pressure distribution threshold value (e.g., 8%) indicates that the comfort of the first region is not good and the user's fatigue is high. Accordingly, the processing unit 320 determines the operating mode of the first massage unit 110 located in the first region to be a third operating mode. In the third operating mode, the massage intensity is higher than the normal massage intensity and the massage frequency is greater than the normal massage frequency.

The determined SPD value of the first region greater than or equal to the first pressure distribution threshold value and less than or equal to the second pressure distribution threshold value indicates that the comfort of the first region is normal and the user's fatigue is moderate. Accordingly, the processing unit 320 determines the operating mode of the first massage unit 110 located in the first region to be a second operating mode. In the second operating mode, the massage intensity corresponds to the normal massage intensity and the massage frequency corresponds to the normal massage frequency.

After the operating mode of the first massage unit 110 is determined, the processing unit 320 transmits a control signal corresponding to the determined operating mode to the first massage unit 110, so that the first massage unit 110 is controlled to operate in the determined operating mode.

Hereinafter, a process of determining whether to operate the first massage unit 110 in an exemplary embodiment of the present disclosure and a process of determining an operating mode of the first massage unit 110 will be described based on a case in which the first region (i.e., the waist region) is divided into 32×24 cells as an example.

Assuming that the first region of the seatback is divided into a 32×24 cell array, the processing unit 320 may obtain 32×24 cell pressure data P(i, j) (here, 1≤i≤32, 1≤j≤24) based on a test pressure distribution cloud map (which is obtained through test software based on test data). Starting from the cells of a first row and a first column, the processing unit 320 sequentially compares the cell pressure data P(i, j) of each cell in the first row with the predetermined reference pressure P_{ref}, counts the cells having the cell pressure data P(i, j) equal to or greater than the predetermined reference pressure P_{ref} among the cells of the first row, and outputs a count value k up to the cells of the 32^{nd} column of the first row. In the same manner, the processing unit 320 sequentially counts the cells having the cell pressure data P(i, j) equal to or greater than the predetermined reference pressure P_{ref} in the second to the twenty-fourth rows to count all the cells having the cell pressure data P(i, j) equal to or greater than the predetermined reference pressure P_{ref} in the 32×24 cell array, and finally outputs a count value k (the k value is stored in the storage unit 330 for subsequent determination of the SPD value). Thereafter, the processing unit 320 determines the EAR using Formula 1 above. For 32×24 cells in the first region, assuming the count value k is 431, the EAR is 56% (greater than 30%), which means that the contact between the user and the first region of the seatback is good, so that the processing unit 320 determines to operate the first massage unit 110 located in the first region.

Thereafter, the processing unit 320, again starting from the cells in the first row and the first column, sequentially compares the cell pressure data P(i, j) of each cell of the 32×24 cell array with the predetermined reference pressure P_{ref}, and determines an average value and a variance value for the cell pressure data P(i, j) of the cells having the cell pressure data P(i, j) equal to or greater than the predetermined reference pressure P_{ref} among the cells of the first row and first column to 24^{th} row and 32^{nd} column. Thereafter, the processing unit 320 determines the SPD value through Formula 2 using the determined average value and variance value. In the case of 32×24 cells in the first region, assuming that the SPD value is 5.73% (greater than 4% and less than 8%), this means that the pressure distribution in the first region is relatively uniform so that the user's fatigue is moderate, and thus, the processing unit 320 determines the operating mode of the first massage unit 110 located in the first region to be the second operating mode. In the second operating mode, the massage intensity corresponds to the normal massage intensity and the massage frequency corresponds to the normal massage frequency.

Similarly, the processing unit 320 processes the received pressure measurement signals of the second region (i.e., the back region) and the third region (i.e., the shoulder region), respectively, to obtain the cell pressure data P(i, j) of the second region and the third region, determines the EARs of the second region and the third region based on the cell pressure data P(i, j), and compares the determined EARs of the second region and the third region with the predetermined massage operation threshold value to determine whether to operate the second massage unit 120 located in the second region or the third massage unit 130 located in the third region.

Additionally, when it is determined to operate the second massage unit 120 located in the second region or the third massage unit 130 located in the third region, the processing unit 320 further determines the SPD value of the second region or the third region based on the m×n cell pressure data P(i, j) of the second region or the third region and compares the determined SPD value of the second region or the third region with the predetermined pressure distribution threshold value to determine the operating mode of the second massage unit 120 located in the second region or the third massage unit 130 located in the third region.

According to various exemplary embodiments of the present disclosure, the process of the processing unit 320 determining whether to operate the first massage unit 110 to the third massage unit 130 for the first region, the second region, and the third region of the seatback and determining the operating mode of the first massage unit 110 to the third massage unit 130 may be performed in parallel or sequentially.

When the operating modes of the first massage unit 110 to the third massage unit 130 are determined, the processing unit 320 transmits a control signal corresponding to the determined operating mode to the first massage unit 110 to the third massage unit 130 through the communication unit 310 to control each of the first massage unit 110 to the third massage unit 130 to operate in the determined operating mode.

FIG. 4 is a flowchart illustrating a process of a method of controlling an adaptive seat massage system according to various exemplary embodiments of the present disclosure.

At step S101, the pressure measurement module 20 detects the pressure applied by the user to the seat in the plurality of regions of the seat, and transmits the pressure measurement signal corresponding to each region of the plurality of regions to the control module 30.

At step S102, the control module 30 determines the EAR of each region among the plurality of regions based on the pressure measurement signal received from the pressure measurement module 20.

At step S103, the control module 30 compares the determined EAR with the predetermined massage operation threshold value to determine whether the EAR is equal to or greater than the massage operation threshold value.

As a result of the step S103, when the EAR is equal to or greater than the massage operation threshold value, the control module 30 determines the SPD value at step S104.

As the result of the step S103, if the EAR is smaller than the massage operation threshold value, the process returns to the step S101 to continue detecting the pressure applied by the user to the seat.

At step S105, the control module 30 compares the determined SPD value with the first pressure distribution threshold value to determine whether the SPD value is smaller than the first pressure distribution threshold value.

As a result of the step S105, if the SPD value is less than the first pressure distribution threshold value, the control module 30 determines the operating mode of the massage module 10 in the corresponding region as the first operating mode at step S109.

As the result of the step S105, if the SPD value is not less than the first pressure distribution threshold value, the control module 30 compares the SPD value with the second pressure distribution threshold value at step S106 to determine whether the SPD value equal to or greater than the first pressure distribution threshold value or less than or equal to the second pressure distribution threshold value.

As a result of the step S106, if the SPD value is greater than or equal to the first pressure distribution threshold value and less than or equal to the second pressure distribution threshold value, the control module 30 determines the operating mode of the massage module 10 in the corresponding region to be the second operating mode at step S110.

As the result of the step S106, if the SPD value is greater than the second pressure distribution threshold value, the control module 30 determines the operating mode of the massage module 10 in the corresponding region to be the third operating mode at step S107.

At step S108, the control module 30 transmits the control signal corresponding to the determined operating mode to the massage module 10, to control the massage module 10 to operate according to the determined massage mode in the corresponding region.

In the adaptive seat massage system and the method of controlling a same included by the exemplary embodiment described above, the pressure applied by the user's body to the different regions of the seatback may be separately measured by use of the plurality of pressure measurement units disposed in the different regions of the seatback and the massage heads of the massage module of the seatback may be dividedly operated by regions and massage intensity/frequency may be controlled dividedly by regions according to different pressures applied to the different regions, so that the massage function of the massage seat may be adaptively adjusted according to the user's body type, weight, and sitting posture.

Although the present disclosure has been referred to as an example in which the massage module and the pressure measurement module are disposed on the seatback, the present disclosure is not limited thereto, and various exemplary embodiments of the present disclosure may be implemented in a seat cushion with a massage function, etc. Furthermore, a various exemplary embodiments of the present disclosure may be implemented in all seats including a massage function other than the vehicle seat.

Exemplary methods of the present disclosure are presented as a series of steps for clarity of description, but this is not intended to limit the order in which steps are performed, and each step may be performed concurrently or in a different order as required. To implement the method according to an exemplary embodiment of the present disclosure, other steps may be included in addition to the illustrated steps, or some steps may be excluded while remaining steps may be included, or some steps may be excluded and other additional steps may be included.

Furthermore, various embodiments of the present disclosure may be implemented through hardware, firmware, software, or a combination thereof. Implementation by hardware may be implemented by one or more application specific integrated circuits (ASICs), digital signal processors (DSPs), digital signal processing devices (DSPDs), programmable logic devices (PLDs), field programmable gate arrays (FPGAs), general-purpose processors, controllers, microcontrollers, microprocessors, etc.

The scope of the present disclosure includes software or machine executable instructions (e.g., operating system, application, firmware, program, etc.) that allow operations according to methods of various embodiments to be executed on a device or computer, a device in which such software or instructions are stored, or a non-volatile computer readable medium executable on a computer.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An adaptive seat massage system comprising:
a massage module configured to provide a massage function in a plurality of regions of a seat;
a pressure measurement module configured to detect pressure applied to the seat by a user in the plurality of regions of the seat and to transmit pressure measurement signal corresponding to respective regions among the plurality of regions; and
a control module electrically connected to the massage module and the pressure measurement module and configured to determine whether to operate the massage module in at least one region among the plurality of regions, based on the pressure measurement signal received from the pressure measurement module, determine, when the massage module is operated in the at least one region, an operating mode of the massage module in the at least one region based on the pressure measurement signal, and transmit a control signal corresponding to the determined operating mode to the massage module to control an operation of the massage module in the at least one region.

2. The adaptive seat massage system of claim 1, wherein the control module includes a processing unit configured to,
when the pressure measurement signal is received from the pressure measurement module, process the received pressure measurement signal to obtain cell pressure data, determine an effective contact area ratio of each region among the plurality of regions based on the cell pressure data, and compare the determined effective contact area ratio of each region with a predetermined massage operation threshold value to determine whether to operate the massage module in the at least one region.

3. The adaptive seat massage system of claim 2, wherein the processing unit is further configured to, when it is determined by the processing unit to operate the massage module in the at least one region, determine a seat pressure distribution value of the at least one region based on the cell pressure data and compare the determined seat pressure distribution value of the at least one region with a predetermined pressure distribution threshold value to determine the operating mode of the massage module in the at least one region.

4. The adaptive seat massage system of claim 3, wherein the processing unit is further configured to divide each of the regions into m×n cells, obtain m×n cell pressure data based on the pressure measurement signal of each region, compare the m×n cell pressure data with a predetermined reference pressure, count cells having the cell pressure data equal to or greater than the reference pressure to obtain a count value, divide the count value by a product of m and n to determine an effective contact area ratio of each of the regions, and determine to operate the massage module in a corresponding region when the determined effective contact area ratio of any one of the plurality of regions is equal to or greater than a massage operation threshold value, wherein m and n are positive integers.

5. The adaptive seat massage system of claim 4, wherein the processing unit is further configured to, when the massage module is operated in any one of the regions, determine an average value and a variance value for the cell pressure data of the cells having the cell pressure data equal to or greater than the reference pressure in the corresponding region, and divide the determined variance value by a value obtained by multiplying a square of the average value by 4 to determine the seat pressure distribution value of the corresponding region.

6. The adaptive seat massage system of claim 5,
wherein the pressure distribution threshold value includes a first pressure distribution threshold value and a second pressure distribution threshold value, and
wherein the processing unit is further configured to:
determine the operating mode of the massage module in the corresponding region to be a first operating mode when the processing unit concludes that the seat pressure distribution value of any one of the determined regions is smaller than the first pressure distribution threshold value,
determine the operating mode of the massage module in the corresponding region to be a second operating mode when the processing unit concludes that the seat pressure distribution value of any one of the determined regions is equal to or greater than the first pressure distribution threshold value and smaller than the second pressure distribution threshold value, and
determine the operating mode of the massage module in the corresponding region to be a third operating mode when the processing unit concludes that the seat pressure distribution value of any one of the determined regions is greater than the second pressure distribution threshold value.

7. The adaptive seat massage system of claim 6,
wherein a massage intensity of the third operating mode is higher than a massage intensity of the second operating mode and a massage frequency of the third operating mode is greater than a massage frequency of the second operating mode, and
wherein the massage intensity of the second operating mode is higher than a massage intensity of the first operating mode and the massage frequency of the second operating mode is greater than a massage frequency of the first operating mode.

8. The adaptive seat massage system of claim 4, wherein the processing unit is further configured to determine not to operate the massage module in the corresponding region, when the determined effective contact area ratio of any one of the determined regions is smaller than the massage operation threshold value.

9. The adaptive seat massage system of claim 4, wherein the control module further includes:
a storage unit configured to pre-store the reference pressure, the massage operation threshold value, and the pressure distribution threshold value; and
a communication unit configured to communicate with the massage module and the pressure measurement module.

10. The adaptive seat massage system of claim 1,
wherein the massage module includes a plurality of massage heads, the plurality of massage heads is arranged in the plurality of regions of the seat, and
wherein the pressure measurement module includes a plurality of pressure sensor arrays, and the plurality of pressure sensor arrays is respectively arranged in corresponding regions of the plurality of regions of the seat.

11. A method of controlling an adaptive seat massage system, the method comprising:
detecting, by a pressure measurement module, pressure applied to a plurality of regions of a seat by a user and transmitting pressure measurement signal corresponding to respective regions among the plurality of regions; and
determining, by a control module electrically connected to the pressure measurement module, whether to operate a massage module electrically connected to the control module, in at least one region among the plurality of regions, based on the pressure measurement signal received from the pressure measurement module, determining, when the massage module is operated in the at least one region, an operating mode of the massage module in the at least one region based on the pressure measurement signal, and transmitting a control signal corresponding to the determined operating mode to the massage module to control an operation of the massage module in the at least one region.

12. The method of claim 11, wherein the determining whether to operate the massage module in the at least one region by the control module includes:
processing, when the pressure measurement signal is received from the pressure measurement module, the received pressure measurement signal to obtain cell pressure data, determining an effective contact area ratio of each region among the plurality of regions based on the cell pressure data, and comparing the determined effective contact area ratio of each region with a predetermined massage operation threshold value to determine whether to operate the massage module in the at least one region.

13. The method of claim 12, wherein the determining the operating mode of the massage module in the at least one region by the control module includes:
determining, by the control module, a seat pressure distribution value of the at least one region based on the cell pressure data when it is determined by the control module to operate the massage module in the at least one region, and comparing the determined seat pressure distribution value of the at least one region with a predetermined pressure distribution threshold value to determine the operating mode of the massage module in the at least one region.

14. The method of claim 13, wherein the determining whether to operate the massage module in the at least one region by the control module further includes:
dividing, by the control module, each of the regions into m×n cells, obtaining m×n cell pressure data based on the pressure measurement signal of each region, comparing the m×n cell pressure data with a predetermined reference pressure, counting cells having the cell pressure data equal to or greater than the reference pressure to obtain a count value, dividing the count value by a product of m and n to determine an effective contact area ratio of each of the regions, and determining to operate the massage module in a corresponding region when the determined effective contact area ratio of any one of the plurality of regions is equal to or greater than the massage operation threshold value, wherein each of m and n is a positive integer, respectively.

15. The method of claim 14, wherein the determining the operating mode of the massage module in the at least one region by the control module further includes:
determining, by the control module, an average value and a variance value for the cell pressure data of the cells having the cell pressure data equal to or greater than the reference pressure in the corresponding region when the massage module is operated in any one of the regions, and dividing the determined variance value by a value obtained by multiplying a square of the average value by 4 to determine the seat pressure distribution value of the corresponding region.

16. The method of claim 15,
wherein the pressure distribution threshold value includes a first pressure distribution threshold value and a second pressure distribution threshold value, and
wherein the determining the operating mode of the massage module in the at least one region by the control module further includes:
determining the operating mode of the massage module in the corresponding region to be a first operating mode when the control module concludes that the seat pressure distribution value of any one of the determined regions is smaller than the first pressure distribution threshold value,
determining the operating mode of the massage module in the corresponding region to be a second operating mode when the control module concludes that the seat pressure distribution value of any one of the determined regions is equal to or greater than the first pressure distribution threshold value and smaller than the second pressure distribution threshold value, and
determining the operating mode of the massage module in the corresponding region to be a third operating mode when the control module concludes that the seat pressure distribution value of any one of the determined regions is greater than the second pressure distribution threshold value.

17. The method of claim 16,
wherein a massage intensity of the third operating mode is higher than a massage intensity of the second operating mode and a massage frequency of the third operating mode is greater than a massage frequency of the second operating mode, and
wherein the massage intensity of the second operating mode is higher than a massage intensity of the first operating mode and the massage frequency of the second operating mode is greater than a massage frequency of the first operating mode.

18. The method of claim 14, wherein
when the determined effective contact area ratio of any one of the plurality of regions is smaller than the massage operation threshold value, the control module is configured to determine not to operate the massage module in the corresponding region.
